(19) United States
(12) Patent Application Publication
(10) Pub. No.: US 2024/0037498 A1
(43) Pub. Date: Feb. 1, 2024

(54) SYSTEMS INCLUDING FUEL STATION AND POWER STATION

(71) Applicant: Propane Fueling Solutions LLC, Houston, TX (US)

(72) Inventors: Mauricio Morafiallos, Fulshear, TX (US); Javier Ramirez, Leesville, TX (US); Miguel Gonzalez, The Woodlands, TX (US)

(21) Appl. No.: 18/355,852

(22) Filed: Jul. 20, 2023

Related U.S. Application Data
(60) Provisional application No. 63/369,491, filed on Jul. 26, 2022.

(51) Int. Cl. G06Q 10/087

(52) U.S. Cl. CPC G06Q 10/087; G05B 2219/37371

(57) ABSTRACT

Examples described herein include methods, techniques, and systems for designing and/or installing an off the grid energy solution. In some embodiments, a system includes a fuel station and a power station, where the fuel station is electrically, communicatively, and mechanically coupled to the power station. The power station may include a plurality of power generation and/or power storage methods, such as via a genset, solar panels, and/or a battery. These electrical power sources, combined with the fuel from the fuel station, contribute to the system being a dependable, standalone energy solution. The system may also utilize a network and a server, where the server comprises a system management module. The system management module may include a fuel management module, a fuel inventory module, and a system maintenance module.

### CROSS-REFERENCE TO RELATED APPLICATIONS

This application claims priority to U.S. Provisional Application 63/369,491, filed Jul. 26, 2022, which application is hereby incorporated by reference, in its entirety, for any purpose.

### BACKGROUND

Fuel stations are often used to meet some of the energy needs of society. However, to engineer, build (or construct), install, and/or operate these fuel stations may require considerable engineering, construction, and/or installation cost(s), and/or a considerable operational cost(s).

The engineering, construction, and/or installation cost(s) may be driven by civil, electrical, mechanical, environmental, and/or process engineering. For example, the fuel station may require electric power to properly operate. To provide the electric power, a builder, an engineer, an installer, and/or an owner of the fuel station may design and/or build an underground electric circuit from a power grid to the fuel station. In such a case, the fuel station needs to be installed and/or operated in a relatively close distance to the power grid, consequently limiting the number of locations that can be selected to install and/or operate the fuel station.

The operational costs of the fuel station may include recurring electricity costs, recurring maintenance costs, repair costs, recurring labor costs (e.g., a labor cost of a fuel station attended, an operator, a manager), and/or recurring costs of other goods and/or services that may be needed to safely operate the fuel station.

Moreover, due to the considerable engineering, construction, and/or installation efforts, it may take an extended time period to engineer, construct, and/or install the fuel station. The extended time period may be particularly disadvantageous in times of need. For example, the times of need may be due to tornadoes, severe storms, hurricanes, tropical storms, floods, wildfires, earthquakes, drought, severe cold weathers, heatwaves, and/or other unfortunate events.

### BRIEF DESCRIPTION OF THE DRAWINGS

FIG. 1 illustrates an example diagram of a system that includes a fuel station and a power station, in accordance with example embodiments.

FIG. 2A, FIG. 2B, FIG. 2C, and FIG. 2D illustrate non-limiting example drawings of the fuel station, in accordance with example embodiments.

FIG. 3 illustrates a non-limiting example drawing of an isometric view of the fuel station and example components of the fuel station, in accordance with example embodiments.

FIG. 4A, FIG. 4B, and FIG. 4C illustrate non-limiting example drawings of the power station and example components of the power station, in accordance with example embodiments.

FIG. 5 illustrates an environment of a first user with a first user device, a second user with a second user device, and a third user with a third user device, where the first, the second, and the third users utilize their respective user devices to communicate with the system, in accordance with examples described herein.

FIG. 6A illustrates an environment of a server that supports and/or includes a cloud-based system management module, where the cloud-based system management module may include a fuel management module, a fuel inventory module, and a system maintenance module, in accordance with examples described herein.

FIG. 6B illustrates an environment of the first user device having and/or utilizing a fuel management application software that is compatible with and/or utilizes the fuel management module, in accordance with examples described herein.

FIG. 6C illustrates an environment of the second user device having a fuel inventory application software that is compatible with and/or utilizes the fuel inventory module, in accordance with examples described herein.

FIG. 6D illustrates an environment of the third user device having a system maintenance application software that is compatible with and/or utilizes the system maintenance module, in accordance with examples described herein.

FIG. 7 illustrates an environment of three example methods of preventing or mitigating a leak, an ignition, and/or an explosion of the liquid fuel at the fuel station, in accordance with examples described herein.

FIG. 8 is a schematic diagram of an electronic recorder according to an embodiment of the present disclosure.

FIG. 9 is a schematic diagram of an inventory measurement controller according to an embodiment of the present disclosure.

### DETAILED DESCRIPTION

This disclosure describes a standalone system that includes a fuel station and a power station. The described fuel station may be a propane station, a diesel station, a hydrogen station, a gasoline station, an ethanol station, a flexible-fuel (e.g., a blend of a plurality of fuels) station, and/or any other station that supplies one or more liquid fuels that are often used to meet some of the energy needs of society. Regardless of the type of liquid fuel used in the system, the fuel station, and the power station, the system may be designed and/or manufactured to meet and/or exceed various national, international, and/or local codes, standards, and/or protocols. For example, if the system uses liquid propane and the system is used in the United States and/or its territories, the system can meet and/or exceed the National Fire Protection Association (NFPA) codes, such as at least the NFPA 58 “Liquefied Petroleum Gas Code” and the NFPA 70 “National Electrical Code.” For the sake of brevity and clarity in the description of the systems and methods described herein, this disclosure focuses on the fuel station being a propane station and some components of the power station using liquid propane from the fuel station. It is to be understood, however, that the systems and methods described herein may be applied to other stations with liquid, liquified, and/or liquefiable fuels.

In some embodiments, the fuel station may be electrically, communicatively, and mechanically coupled to the power station. The power station may include a plurality of power generation and/or power storage methods, such as via a genset, solar panels, and/or a battery. These electrical power sources, combined with the fuel from the fuel station contribute to the system being a dependable, standalone energy solution. The system may also utilize a network and a server, where the server comprises a system management module. The system management module may include a fuel management module, a fuel inventory module, and a system maintenance module.

In some instances, units of measurements may be expressed using le Système International d'Unités (the International System of Units, abbreviated from the French as the “SI” units), or may be colloquially referred to as the “metric system.” Additionally, or alternatively, units of measurements may be expressed using other units, for example, units defined in the United States Customary System.

The terms “charge,” “energy,” and “power,” for example, “electric charge,” “electric energy,” and “electric power,” may be used interchangeably, in part, because these terms may be related. Further, the terms “power” and/or “electric power” may be expressed in units of Watts (W) and/or a derivative thereof, for example, kilowatt (kW), kilowatt-hour (kWh), and the like. Persons having ordinary skill in art can infer and/or differentiate these terms based on context, industry usage, academic usage, linguistic choice, and/or other factors.

Aspects of certain embodiments described herein may be implemented as software modules or components. As used herein, a software module or component may include any type of computer instruction or computer-executable code located within or on a computer-readable storage medium, such as a non-transitory computer-readable medium. A software module may, for instance, comprise one or more physical or logical blocks of computer instructions, which may be organized as a routine, program, object, component, data structure, etc. that perform one or more tasks or implement particular data types, algorithms, and/or methods.

A particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks may be performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network.

In some instances, the embodiments of the disclosure may be understood by reference to the drawings. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, but it is merely representative of possible embodiments. In addition, the steps of a method do not necessarily need to be executed in any specific order, or even sequentially, nor need the steps be executed only once, unless otherwise specified. Further, while the various aspects of the embodiments are presented in drawings, the drawings are not necessarily drawn to scale.

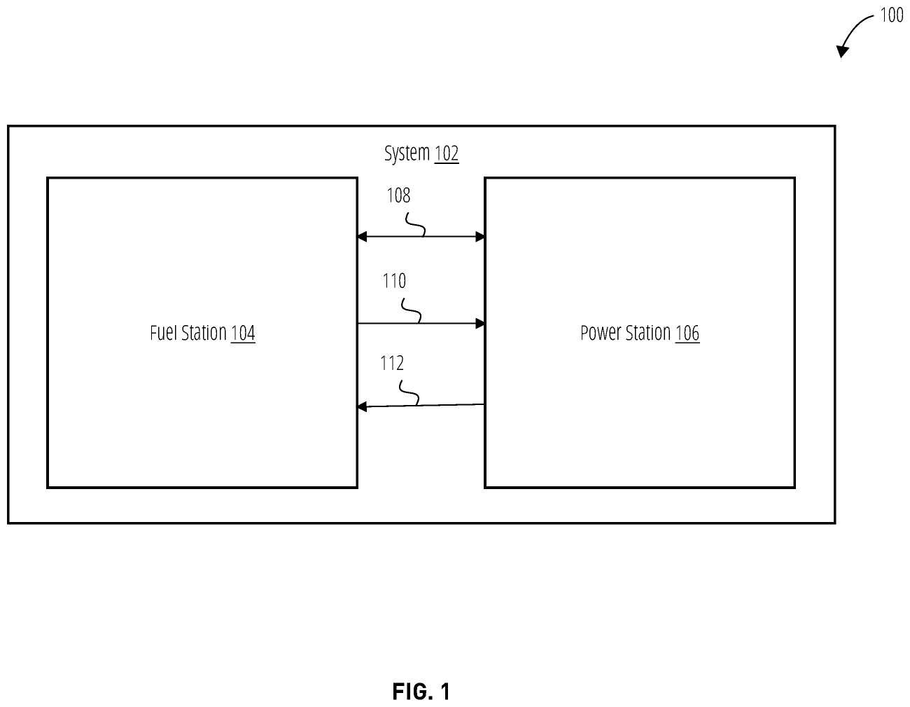

FIG. 1 illustrates an example diagram 100 of a system 102 that includes a fuel station 104 and a power station 106, in accordance with example embodiments. In some embodiments, the power station 106 may include a genset (e.g., a liquid propane genset), a solar panel, a direct current (DC) to alternating current (AC) converter, an AC-to-DC converter, a battery, a battery charger, and/or other components that may be used to enable the system 102 to be operated off a power grid (e.g., a standalone system 102). The system 102, however, can be integrated to the power grid.

In the United States, in part, due to code requirements (e.g., NFPA 58, NFPA 70), the fuel station 104 and the power station 106 may be designed and/or installed as two separate units with a threshold distance (e.g., 6, 7, 10 meters, and/or other distances that may be required by the NFPA 58) between the fuel station 104 and the power station 106. Nevertheless, instead of modular units, the fuel station 104 and the power station 106 can be designed as a single unit. For example, the fuel station 104 and the power station 106 can be mounted on a same skid.

In some embodiments, the power station 106 may communicate with the fuel station 104 using at least one communication signal 108. In FIG. 1, the signal 108 is illustrated as a bidirectional communication signal. Nevertheless, the system 102 may include a variety and/or a plurality of wired, wireless, unidirectional, bidirectional, and more-than-two directional communication signals (e.g., duplex telecommunication). Furthermore, although not illustrated in FIG. 1, the system 102 may include and/or utilize additional communication signals to communicate with a user device (e.g., a smartphone, a desktop, a laptop), one or more base stations, a satellite(s), a computing cloud, a network(s), and so forth.

In some embodiments, the system 102 may include at least one mechanical coupling 110 to couple (or connect) the fuel station 104 to the power station 106. For example, the mechanical coupling 110 may be and/or include piping and/or fitting to transfer liquid propane from the fuel station 104 to the genset of the power station 106.

In some embodiments, the system 102 may include at least one electrical coupling 112 (e.g., electrical connection, circuit) to electrically couple (or connect) the fuel station 104 to the power station 106. For example, using the at least one electrical coupling 112, the power station 106 may provide AC and/or DC power to one or more components of the fuel station 104. Although not illustrated in FIG. 1, the system 102 may include additional electrical coupling(s) to, for example, provide AC and/or DC power to components outside the system 102. For example, the genset of the power station 106 may serve as a backup genset to power electric components of a building, one or more electrically powered equipment and/or device, and/or so forth.

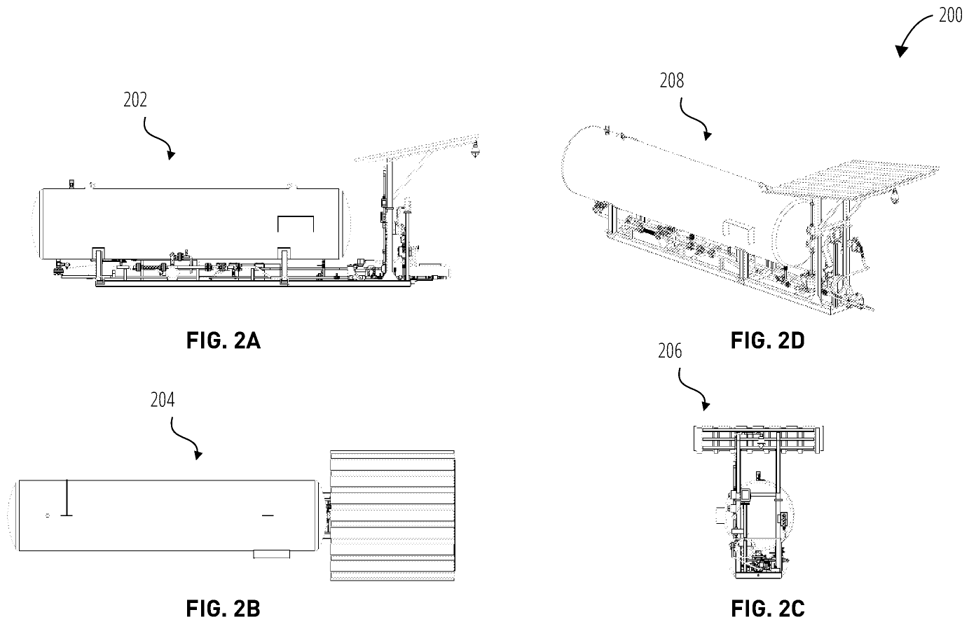

FIG. 2A, FIG. 2B, FIG. 2C, and FIG. 2D illustrate non-limiting example drawings 200 of a first view, a second view, a third view, and a fourth view of the fuel station 104 of FIG. 1, respectively, in accordance with example embodiments. FIG. 2A, FIG. 2B, FIG. 2C, and FIG. 2D are described in the context of FIG. 1. In more detail, the first view of FIG. 2A is a front view 202 of the fuel station 104, the second view of FIG. 2B is a top view 204 of the fuel station 104, the third view of FIG. 2C is a side view 206 of the fuel station 104, and the fourth view of FIG. 2D is an isometric view 208 of the fuel station 104. The dimension(s), the shape(s), the aesthetic form(s), and/or ratios of the dimension(s) of the fuel station 104 may differ depending on preferences, needs, and/or requirements of users, operators, customers, and/or owners of the fuel station 104 and/or the system 102.

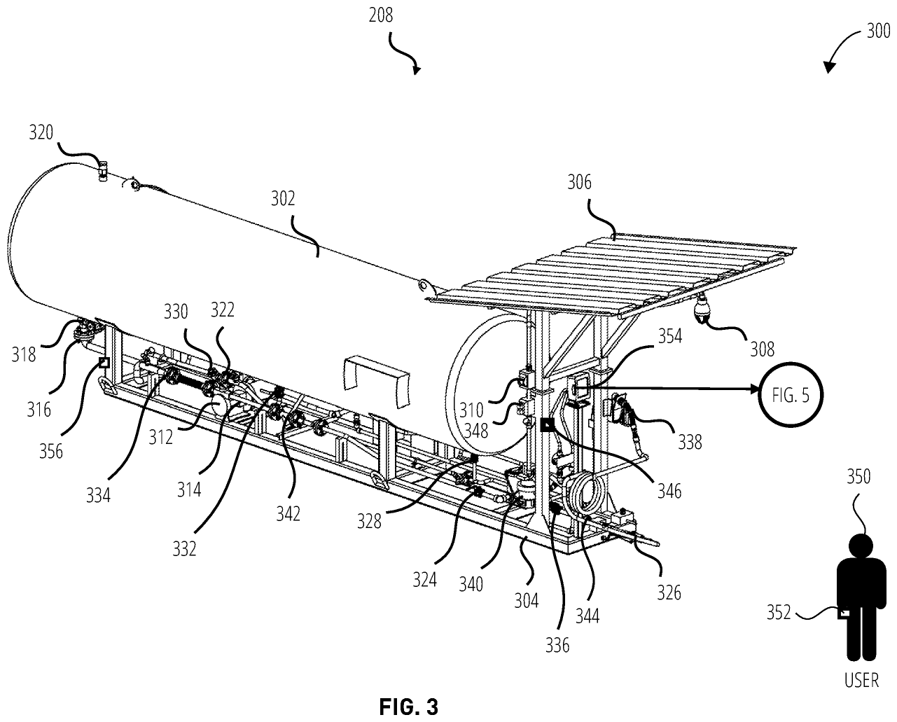

FIG. 3 illustrates a non-limiting example drawing of an isometric view 300 of the fuel station 104 and example components of the fuel station, in accordance with example embodiments. The isometric view 300 may be an enlarged view of the isometric view 208 of FIG. 2. The isometric view 300 of FIG. 3 includes placements of some components of the fuel station 104, in accordance with example embodiments. For clarity, FIG. 3 is illustrated and/or described in the context of FIG. 1, FIG. 2A, FIG. 2B, FIG. 2C, FIG. 2D, and the description(s) thereof.

In some embodiments, the fuel station 104 may include a fuel tank 302 (e.g., a 600-, 1,000-, 1,300-gallon tank, etc.) that be mounted on a first skid 304 (e.g., the skid of fuel station 104). The first skid 304 may also include and/or support a roof 306 that may protect a user and/or some of the components of the fuel station 104 from some environmental elements. The roof 306 may also include and/or support lighting 308 that may increase a user's visibility. The lighting 308 may be activated or deactivated using a motion sensor(s) and/or a light sensor(s). Additionally, or alternatively, the lighting 308 may be activated or deactivated using a light switch 310 that may be mounted on the first skid 304. In some examples, the first skid 304 may include one or more solar panel(s) (not shown) on the roof 306. The solar panel(s) may include, for example, photovoltaic solar panels (e.g., monocrystalline solar panels and/or polycrystalline solar panels) and/or other solar panel technologies.

The fuel station 104 may include a pump 312 that may be operated by an electric motor 314. In some embodiments, the pump 312 and the electric motor 314 may be installed within a protection zone of the fuel tank 302. For example, the pump 312 and the electric motor 314 may be mounted on the first skid 304 and underneath the fuel tank 302. In a case when the fuel station 104 is a propane station, the pump 312 may be a regenerative turbine pump that may be purposely designed to be used in liquified petroleum gas (LPG) applications. Furthermore, the electric motor 314 may be suitable (e.g., rated) for operating in hazardous atmospheres and/or environments (e.g., environments with flammable and/or combustible vapors). For clarity, the rating of the electric motor 314 may meet or exceed industry best practices and/or one or more codes, such as the NFPA 58 and the NFPA 70. Furthermore, regardless of the type of the pump, the electric motor 314 can be sized and/or installed (e.g., wired, grounded) to support the operation of the pump 312 and the sizing and/or the installation of the electric motor 314. The sizing and/or the installation of the electric motor 314 may also meet or exceed the NFPA 58 and/or the NFPA 70 codes and/or standards. In some embodiments, the electric motor 314 may be a two-horsepower (2 hp) single-phase (1 ϕ) electric motor with a nominal voltage of 220 volts (V).

In some embodiments, to reduce or eliminate exposed wiring, the cavities of the first skid 304 may be used in in lieu of, or in addition to, conduits. Note that FIG. 3 is not intended to illustrate the circuits (e.g., wiring, grounding) and/or conduits in detail. Furthermore, FIG. 3 and/or any other figure in this disclosure do not illustrate wiring and/or grounding diagrams. A person skilled in the art understands the codes, standards, and/or industry practices guiding the proper installation of mechanical, electrical, electromechanical, and/or so types of components.

Although not described and/or illustrated in extensive detail, the fuel station 104 can include and/or utilize piping(s) and/or fitting(s) that may meet or exceed the requirements of NFPA 58, industry practices, and/or other regulations and/or requirements. Furthermore, the fuel station 104 may include and/or utilize various actuators, mechanical valves, hydraulic valves, pneumonic valves, and/or electromechanical valves (e.g., pneumatic/electrical solenoid valves) that allow for proper and/or safe operation of the fuel station 104. For the sake of brevity, FIG. 3 illustrates some non-limiting examples of the actuators, hydraulic valves, pneumonic valves, and/or electromechanical valves that may be utilized by the fuel station 104.

For example, the fuel station 104 may include and/or utilize an actuator(s) 316, such as a pneumatic actuator. As another example, the fuel station 104 may include and/or utilize a plurality of mechanical valves, such as a first internal valve(s) 318, a first pressure-relief valve(s) 320, a second pressure-relief valve(s) 322, a first excess-flow valve(s) 324, a second excess-flow valve(s) 326, a ball valve(s) 328, a bypass valve(s) 330, and/or other mechanical valves. Note that some of the mechanical valves may also be manually operated by an operator of the fuel station 104. As another example, the fuel station 104 may include and/or utilize a second internal valve(s) 332, where the second internal valve(s) 332 includes and/or utilizes a pneumatic actuator. As yet another example, the fuel station 104 may include and/or utilize AC and/or DC powered solenoid valves, such as a first electrically powered solenoid valve(s) 334 (e.g., a three-way solenoid valve), a second electrically powered solenoid valve(s) 336 (e.g., a two-way solenoid valve), and/or other AC- and/or DC-powered solenoid valves (e.g., pneumatic/electrical solenoid valves) that may not be explicitly illustrated and/or described herein.

As is illustrated in FIG. 3, the fuel station 104 may include and/or utilize a nozzle(s) 338 that may be used by a customer (or user) to purchase a desired amount of liquid fuel. To measure and/or control the amount of liquid fuel that may be dispensed using the nozzle(s) 338, the fuel station 104 may also include and/or utilize a volumetric meter 340. In some embodiments, the volumetric meter 340 may include and/or utilize another solenoid valve.

In some embodiments, however, the fuel station 104 may not include the nozzle(s) 338. For example, an entity may not be interested in using the fuel station 104 to sell liquid fuel; instead, the entity may utilize the system 102 as a ready-to-use packaged energy solution during blackouts, brownouts, and/or scheduled maintenances of a power grid. Also, note that the fuel station 104 may include a fuel filter 342 and/or other fuel filters that may not be explicitly illustrated.

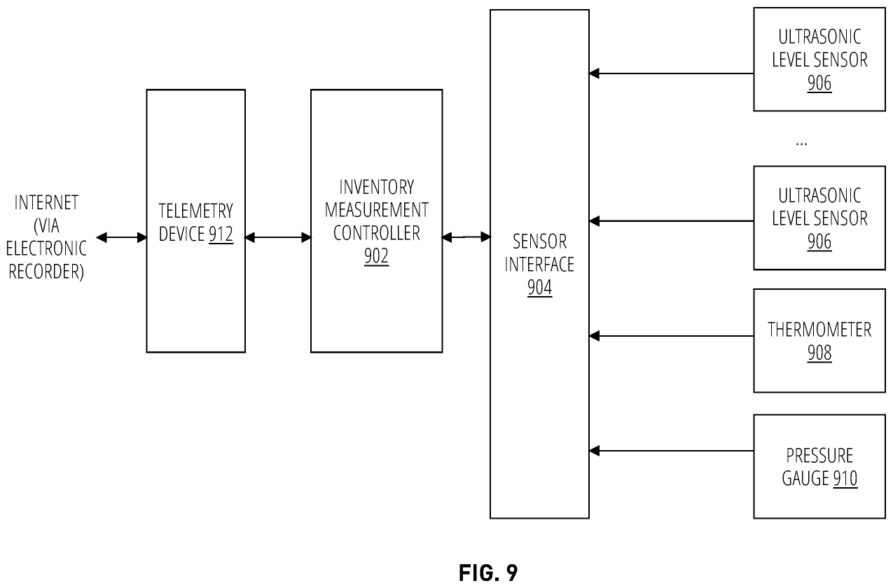

The fuel station 104 and/or the fuel tank 302 may include and/or utilize various measuring instruments, such as an ultrasonic level sensor (e.g., ultrasonic level sensors 906 in FIG. 9), a pressure gauge 344 (e.g., a pressure gauge 910 in FIG. 9), a barometer (not illustrated), a thermometer (e.g., a thermometer 908 in FIG. 9), and/or other gauges and/or measuring instruments. One, some, or all of these measuring instruments may communicate the readings to, for example, an Internet-of-Things (IoT) device 346 using a wireless communication protocol(s), such as a Modbus serial communication protocol. Wireless communication may be considerably advantageous in hazardous environments, since these environments may be flammable (or even explosive), and the wireless communication may carry a lower risk of igniting a fire (or causing an explosion) compared to a wired communication. Should, however, the system 102 include wired communication, the wiring, the conduits, and the installation(s) of the wiring and conduits may meet or exceed the various codes, standards, and/or industry best practices for hazardous environments.

Current (e.g., prior art) solutions often utilize float gauge technologies to measure and/or monitor the amount of liquid fuel in a fuel tank. These float gauges, however, often operate with a margin of error that may not be negligible (e.g., a margin of error of 4%, 5%, 6%). In some embodiments, such as in industrial and/or business operations, the margin of error of the float gauges may hinder the logistical and/or inventory efficiencies. For example, if a propane distributor operates and/or serves tens, hundreds, and/or thousands of fuel stations, a 4-6% margin of error may be significant and may adversely impact the distributor's revenues and/or profits. In such a case, the propane distributor may make premature, late, and/or additional trips to refuel the fuel stations. It is to be appreciated that the fuel station 104 includes and/or utilizes the ultrasonic level sensor to measure the amount of fuel in the fuel tank 302, since the ultrasonic level sensor may measure the level (e.g., the amount, the volume) of the liquid fuel with a lower-than-1% margin of error (e.g., a margin of error of 0.5%). Therefore, the ultrasonic level sensor of the fuel tank 302 may help increase the accuracy of liquid fuel (e.g., propane) measurements.

As may be required by code (e.g., the NFPA 58), the fuel station 104 may include an emergency stop 348. Current solutions (e.g., prior art) may often use a first emergency stop button (or switch) to deenergize electrical components of a fuel station, and a second emergency stop button (or switch) to shut off the mechanical components (e.g., valves) of the fuel station (e.g., to shut off a fuel tank). Although the current solutions may meet code, such solutions may require a two-step process in times of emergency (e.g., a liquid fuel leak). By contrast, with one press of the emergency stop 348 of the fuel station 104, a user can deenergize the electrical components of the fuel station 104 and shut off the mechanical components of the fuel station 104. For example, some of the valves of the fuel station 104 may be pneumatic/electric solenoid valves (may be described herein as “pneumatic solenoid valves”), where pneumatic actuators of the pneumatic solenoid valves can use pneumatic pressure to open the valves. So, if there is a loss of power, or an interruption of power, to the pneumatic solenoid valves, the pneumatic solenoid valves deenergize and release the pneumatic pressure that was used to open the valves. Therefore, in a case of an emergency, when the user presses the emergency stop 348, power to the pneumatic solenoid valves is interrupted; consequently, the pneumatic pressure is released, and the pneumatic solenoid valves stop the flow of fuel supply.

Furthermore, code (e.g., the NFPA 58) may also require that an emergency stop be installed a minimum threshold (e.g., 50 feet or more) away from the fuel station 104. To meet this second code requirement, a user 350 may utilize a remote actuation emergency stop(s) 352 to wirelessly activate the emergency stop 348 that is mounted on the first skid 304, while maintaining a safe distance (e.g., 30, 50, 100, 300 feet, etc.) from the fuel station 104. To do so, the remote actuation emergency stop(s) 352 may communicate with emergency stop 348 using a radio communication protocol to activate a relay of the emergency stop 348. The activation of the relay of the emergency stop 348 may perform the same function as manually pressing the emergency stop 348. It is to be appreciated that the remote actuation emergency stop(s) 352 may meet or exceed code requirements (e.g., the NFPA 58), may improve operator safety by adding another means (e.g., in addition to emergency stop 348) of shutting off mechanical and electrical components of the fuel station 104, may be used from numerous locations (e.g., a radius of 30, 50, 100, or 300 feet from the fuel station 104), and/or may be more cost-effective than installing another wired emergency stop that may be located a minimum threshold distance away from the fuel station 104.

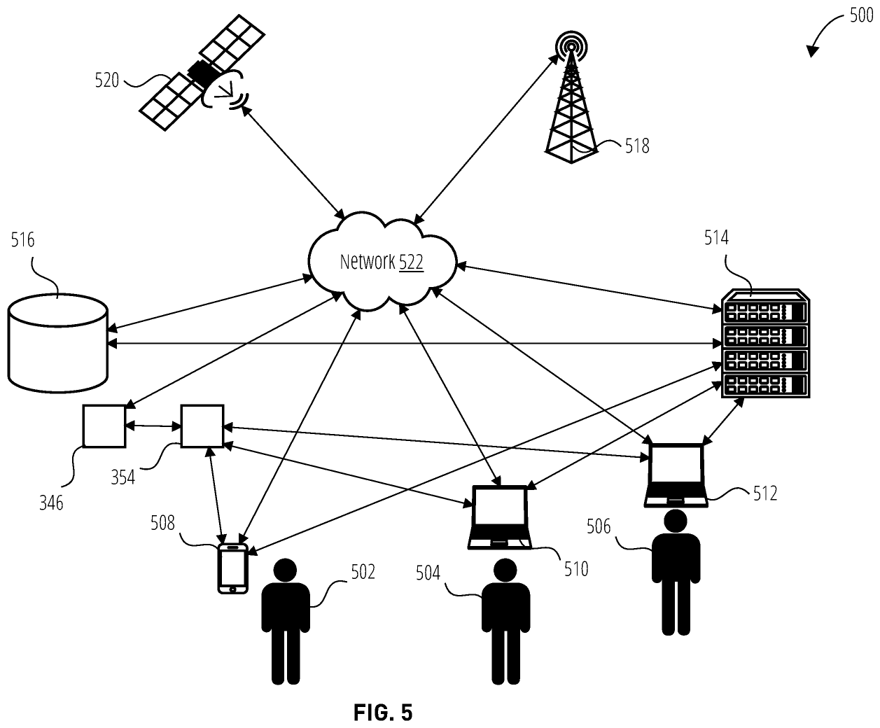

In some embodiments, the fuel station 104 may utilize and/or include an electronic recorder 354 (or a controller) of FIG. 3 for recording data that may reported by one or more components of the system 102. Furthermore, the electronic recorder 354 may communicate with the IoT device 346. The IoT device 346 may then communicate the data received from the electronic recorder 354 and the data received from any component, gauge, sensor, and/or instrumentation using one or more communication protocols. In some embodiments, the electronic recorder 354 and/or the IoT device 346 may be integrated, communicate, and/or operate in situ with a cloud-based system management module (“system management module”), where the system management module may include a fuel management module, a fuel inventory module, and a system maintenance module. In some embodiments, the system management module may be stored and/or executed on a server (e.g., a server 514 of FIG. 5). In addition, the system management module may access and/or may include a database (e.g., a database 516 of FIG. 5).

In some embodiments, the fuel station 104 may include a sacrificial anode(s) 356 (e.g., a galvanic anode(s)) that may provide galvanic cathodic protection to limit, reduce, or avoid a corrosion of metallic structures that may be exposed to humidity. Depending on the climate where the system 102 may be installed, these sacrificial anode(s) 356 may extend the life of the fuel station 104, the power station 106, and/or the system 102. FIG. 3 illustrates one sacrificial anode(s) 356; however, the fuel station 104 may include a plurality of sacrificial anode(s) 356 installed on the first skid 304, the fuel tank 302, and/or other components (e.g., including components of the power station 106) that may require additional corrosion protection.

Additionally, or alternatively, one, some, or all of the metallic components of the fuel station 104 and/or the power station 106 may be coated with a variety of anti-corrosion coatings. These anti-corrosion coatings may protect the metallic component(s) against degradation due to moisture, salt spray, oxidation, or exposure to a variety of environmental (or industrial) degrading elements. Additionally, or alternatively, one, some, or all of the metallic components of the fuel station 104 and/or the power station 106 may include coatings that can provide an abrasion resistance, a non-stick performance, and/or a chemical protection.

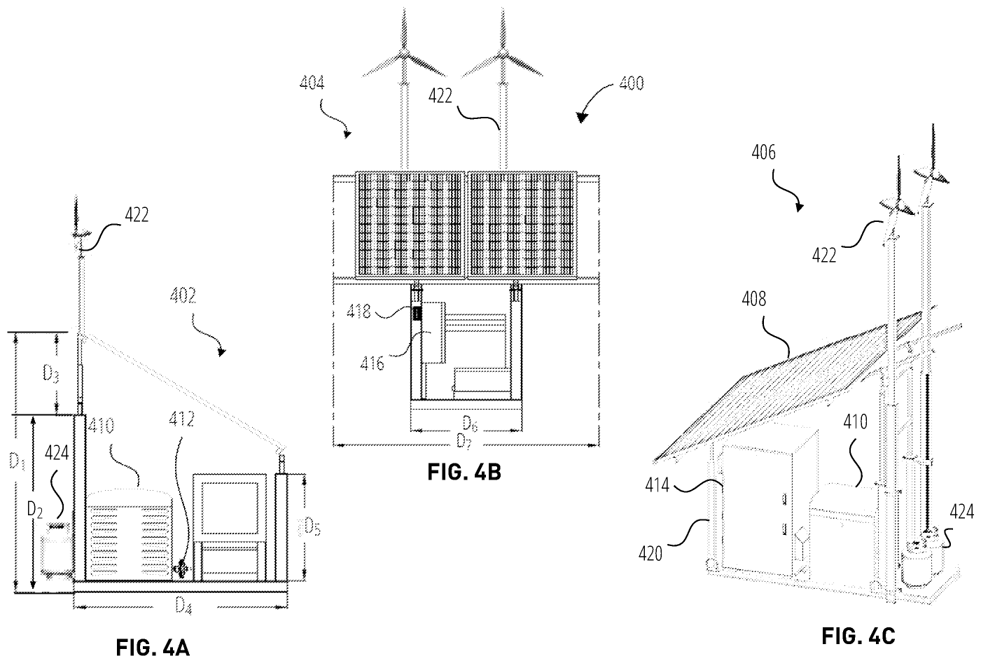

FIG. 4A, FIG. 4B, and FIG. 4C illustrate non-limiting example drawings 400 of a first view, a second view, and a third view of the power station 106 of FIG. 1, respectively, in accordance with example embodiments. FIG. 4A, FIG. 4B, and FIG. 4C are described in the context of FIG. 1, FIG. 2A, FIG. 2B, FIG. 2C, FIG. 2D, and FIG. 3, and the description(s) thereof. The first view of FIG. 4A is a front view 402 of the power station 106, the second view of FIG. 4B is a side view 404 of the power station 106, and the third view of FIG. 4C is an isometric view 406 of the power station 106.

In some embodiments, the power station 106 may include a solar panel(s) 408, an engine-generator 410 (“genset 410”), a regulator 412, a battery 414, an electrical panel(s) 416 (or an electrical box) with one or more electrical component(s), an emergency stop 418, a wind turbine(s) 422, a propane tank(s) 424, and/or other components that may be mounted on a second skid 420 (e.g., the skid of the power station 106).

Since in the example drawings 400 the solar panel(s) 408 covers the whole power station 106, a top view of the power station 106 is omitted from the figures of this disclosure. In some embodiments, the dimension(s) (e.g., D1, D2, D3, D4, D5, D6, D7), the shape(s), the esthetic form(s), and/or ratios of the dimension(s) of the power station 106 may differ depending on the preferences, needs, and/or requirements of the users, operators, and/or customers. For example, the dimension D3 may be adjusted to increase an amount of solar power being captured by the solar panel(s) 408.

In some embodiments, the solar panel(s) 408 may be, include, and/or utilize photovoltaic solar panels (e.g., monocrystalline solar panels and/or polycrystalline solar panels) and/or other solar panel technologies. Example non-limiting power capacities of the solar panel(s) 408 may be 300 W, 400 W, 500 W, 1 kW, 2 kW, and/or other power output capacities. An output voltage of the solar panel(s) 408 may be 24 V_{DC}.

In some embodiments, the power station 106 may include a DC-to-AC inverter that may be mounted and/or installed in the electrical panel(s) 416. The size (e.g., rating) of the DC-to-AC inverter may be equal to, or greater than, the output power of the solar panel(s) 408. For example, if the output of the solar panel(s) 408 is 400 W, the DC-to-AC inverter may be sized as 400 W or greater. In some embodiments, the input voltage of the DC-to-AC inverter may be 24 V_{DC}, and the output voltage of the DC-to-AC inverter may be, for example, 120 V_{AC} (e.g., when installed in the United States).

The genset 410 of the power station 106 is a set that includes an electrical generator (e.g., an alternator) and an engine (e.g., a prime mover). The electrical generator and the engine of the genset 410 may be enclosed to form a single equipment, as is illustrated in the drawings 400. Depending on the location of the system 102, the enclosure of the genset 410 may include insulation material to muffle the noise of the engine of the genset 410 and/or to protect the genset 410 from cold temperatures. Additionally, or alternatively, the genset 410 may include and/or utilize fans and/or some other cooling system to protect the genset 410 from overheating. The genset 410 may be powered using the fuel of the fuel tank 302. Therefore, in the case of the fuel station 104 being a propane station, the genset 410 may be a liquid propane (LP) gas genset. The size of the genset 410 may differ depending on the application of the system 102. To that end, the genset 410 may be a 5 kilowatt (kW), 12 kW, 25 kW, 50 kW, 100 kW, or another genset size. Furthermore, still depending on the application of the system 102, the genset 410 may output a single-phase AC power or a three-phase AC power. Also, depending on the continent, country, and/or territory, the genset 410 may output a 50 Hertz (Hz) AC power (e.g., if the system 102 is installed in Europe) or a 60 Hz AC power (e.g., if the system 102 is installed in the United States). In some embodiments, although not illustrated as such, the power station 106 may include a plurality of gensets. For example, a first genset may output a single-phase (1 ϕ) AC power, and a second genset may output a three-phase (3 ϕ) AC power. Yet, via proper piping and/or fitting (e.g., mechanical coupling 110 of FIG. 1), the plurality of gensets may still be supplied with fuel by a single fuel station (e.g., the fuel station 104). Note, as is illustrated in FIG. 4A, the piping and/or fitting of genset 410 may include a regulator 412.

In some embodiments, the genset 410 may be further powered using the wind turbine(s) 422 and/or the propane tank(s) 424 provided at or proximity to the second skid 424 as backup power supply sources.

In some embodiments, the electrical panel(s) 416 may also include one or more breakers, one or more switches, one or more fuses, a solar charge-and-discharge controller, a battery charger, a combination thereof, and/or other components that may enable the power station 106 to safely operate, energize, deenergize, and/or protect the components and/or an operator of the power station 106 and/or the system 102.

In aspects, the output power of the solar panel(s) 412 may also be stored in the battery 414 for later use. The battery 414 may utilize a deep cycle technology, where the battery 414 may be, for example, a 12 V_{DC}, with a current rating of 100, 200, 300, or different Ampere hour (Ah). In some embodiments, the battery charger may have an input voltage of 120/240 V_{AC}, an output voltage of 24 V_{DC}, and a charging current of 15 A.

In some embodiments, the emergency stop 418 of the power station 106 may be similar to, equivalent to, or the same as the emergency stop 348 of the fuel station 104. Similarly, the emergency stop 418 of the power station 106 may also be wirelessly activated by the same remote actuation emergency stop(s) 352 or a different remote actuation emergency stop.

In some embodiments, the genset 410, the battery 414, the solar panel(s) 408, and/or other components of the power station 106 may include and/or utilize respective digital outputs. For example, a digital output of the solar panel(s) 408 may include data related to the output power of the solar panel(s) 408. As another example, a digital output of the genset 410 may include data related to count of hours that the engine of the genset 410 has been running since the last oil change. As another example, another digital output of the genset 410 may include data related to the amount of power generated by the genset 410. As yet another example, a digital output of the battery 414 may include data related to a state of charge of the battery 414 (e.g., 10%, 20%, . . . , 90% charge, or full charge). In short, generally, one, some, or all of the components of the power station 106 may include output data related to the health, operation efficiency, electrical faults, and other output data. These output data may be transmitted to and stored at the electronic recorder 354. Therefore, even though the electronic recorder 354 may be installed at the first skid 304 of the fuel station 104, the electronic recorder 354 may also support part of the functionalities of the power station 106.

It is to be appreciated that the power station 106 offers a plurality of power generation and/or power storage methods, such as via the genset 410, the solar panel(s) 408, and the battery 414. These electrical power sources, combined with the fuel from the fuel station 104, contribute in the system 102 being a dependable, standalone energy solution.

FIG. 5 illustrates an environment 500 of a first user 502, a second user 504, and a third user 506 communicating with the system 102, in accordance with examples described herein. FIG. 5 is described in the contexts of FIG. 1, FIG. 2A, FIG. 2B, FIG. 2A, FIG. 2D, FIG. 3, A4, 4B, and 4C and the descriptions(s) thereof. The first user 502, the second user 504, and the third user 506 may be three separate users, a combination of two user, or a same user. In part, FIG. 5 illustrates three separate users to add clarity in the descriptions of the different interactions with the system 102.

In some embodiments, the first user 502 may utilize a first user device 508, the second user 504 may utilize a second user device 510, and the third user 506 may utilize a third user device 512. FIG. 5 illustrates the first user device 508 as being a smartphone, the second user device 510 as being a laptop computer, and the third user device 512 as being another laptop computer. Nevertheless, any of the user devices may be a variety of devices, such as a desktop computer, a laptop, a smartphone, a wearable device, a notebook, and/or other examples of user devices that may enable the first user 502, the second user 504, and/or the third user 506 to interact with, monitor, and/or operate the system 102.

In some embodiments, the environment 500 may include the electronic recorder 354 of the fuel station 104, the IoT device 346 of the fuel station 104, a server 514 associated with and/or supporting the system 102, a database 516 associated with and/or supporting the system 102, a base station(s) 518, a satellite(s) 520, a network 522, and/or other devices and/or components.

In some embodiments, the various devices and/or components in the environment 500 may communicate with each other directly and/or via the network 522. The network 522 may facilitate communication between the first user device 508, the second user device 510, the third user device 512, the IoT device 346, the server 514, the database 516, the base station(s) 518, the satellite(s) 520, and/or other components (e.g., other user devices) that may not be explicitly illustrated in FIG. 5. Communication(s) in the environment 500 of FIG. 5 may be performed using various protocols and/or standards. Examples of such protocols and standards include a 3rd Generation Partnership Project (3GPP) Long-Term Evolution (LTE) standard, such as a 4th Generation (4G) or a 5th Generation (5G) cellular standard; an Institute of Electrical and Electronics (IEEE) 802.11 standard, such as IEEE 802.11g, ac, ax, ad, aj, or ay (e.g., Wi-Fi 6® or WiGig®); an IEEE 802.16 standard (e.g., WiMAX®); a Bluetooth Classic® standard; a Bluetooth Low Energy® or BLE® standard; an IEEE 802.15.4 standard (e.g., Thread® or ZigBee®); an open serial communication protocol (e.g., Modbus, Modbus RTU); other protocols and/or standards that may be established and/or maintained by various governmental, industry, and/or academia consortiums, organizations, and/or agencies; and so forth. Therefore, the network 114 may be a cellular network, the Internet, a wide area network (WAN), a local area network (LAN), a wireless LAN (WLAN), a wireless personal-area-network (WPAN), a mesh network, a wireless wide area network (WWAN), a peer-to-peer (P2P) network, and/or a Global Navigation Satellite System (GNSS) (e.g., Global Positioning System (GPS), Galileo, Quasi-Zenith Satellite System (QZSS), BeiDou, GLObal NAvigation Satellite System (GLONASS), Indian Regional Navigation Satellite System (IRNSS), and so forth).

In some embodiments, the first user 502 may be a customer who may desire to purchase LP stored in the fuel tank 302 of FIG. 3 of the fuel station 104. For example, the first user 502 may desire to fill a fuel tank of a vehicle (not illustrated). After the first user 502 couples the nozzle(s) 338 of the fuel station 104 to the fuel tank of their vehicle, the first user 502 may utilize the first user device 508 (e.g., a smartphone) to communicate with the electronic recorder 354 of the fuel station 104. By so doing, the first user device 508 helps the first user 502 initiate a liquid-fuel-purchasing transaction. The first user device 508 may communicate wirelessly with the electronic recorder 354 using, for example, a Bluetooth Classic® communication protocol or a BLE® communication protocol.

In some embodiments, the system 102 may be installed in a remote location with little or no supporting wired communication infrastructure. Furthermore, the electronic recorder 354 may not be able to transmit or receive data using, for example, the base station(s) 518. In such a case, the electronic recorder 354 may communicate with the IoT device 346 using a first communication protocol and/or standard, for example, a Bluetooth Low Energy® or a BLE® protocol and/or standard. In turn, the IoT device 346 may communicate with the base station(s) 518 using a cellular communication protocol and/or standard, such as an LTE protocol and/or standard. Furthermore, the IoT device 346 may communicate with the server 514 and/or the database 516 using cellular communication and/or standard via, for example, the base station(s) 518. Therefore, it is to be appreciated that even in remote locations, the system 102 may communicate the data of the electronic recorder 354, the IoT device 346, and/or another device using the network 522, the base station(s) 518, and/or the satellite(s) 520.

In some embodiments, the second user 504 may be associated with and/or working for a fuel distributor. In such a case, the second user 504 may be primarily interested on the amount of fuel inside the fuel tank 302 (e.g., fuel inventory), and the second user 504 may use the second user device 510 to access data indicating the amount of fuel inside the fuel tank 302. By so doing, the second user 504 may make an informed decision regarding when to refuel the fuel station 104. Such an informed decision may help the fuel distributor to better manage the fuel inventory, reduce transportation costs by avoiding premature trips to the fuel station 104, and/or increase customer and/or the fuel station 104's owner satisfaction by avoiding late arrival(s) to refuel the fuel tank of the fuel station 104.

In some embodiments, the third user 506 of FIG. 5 may be an operator, an owner, a maintenance worker, an engineer, and/or the like of the system 102. The third user 506 may not be interested in initiating a transaction, since the second user 504 may not be a customer of the system 102. However, the second user 504 may be interested in data related to alarms, notifications, the health of the components of the system 102, and/or other maintenance, performance, and/or safety related data of the system 102. Furthermore, even though the data related to the alarms, the notifications, the health of the components of the system 102, and/or the other maintenance, performance, and/or safety related data of the system 102 may be locally stored and/or viewed at the electronic recorder 354, instead of going onsite (e.g., at or near the system 102), the second user 504 may use the second user device 510 to communicate with the server 514 and/or access data stored in the database 516.

In addition to, or alternatively of, the communications illustrated in FIG. 5, the environment 500 may facilitate other unidirectional, bidirectional, wired, wireless, direct, and/or indirect communications utilizing one or more communication protocols and/or standards. Therefore, FIG. 5 does not necessarily illustrate all of the communication signals that may be utilized in this disclosure.

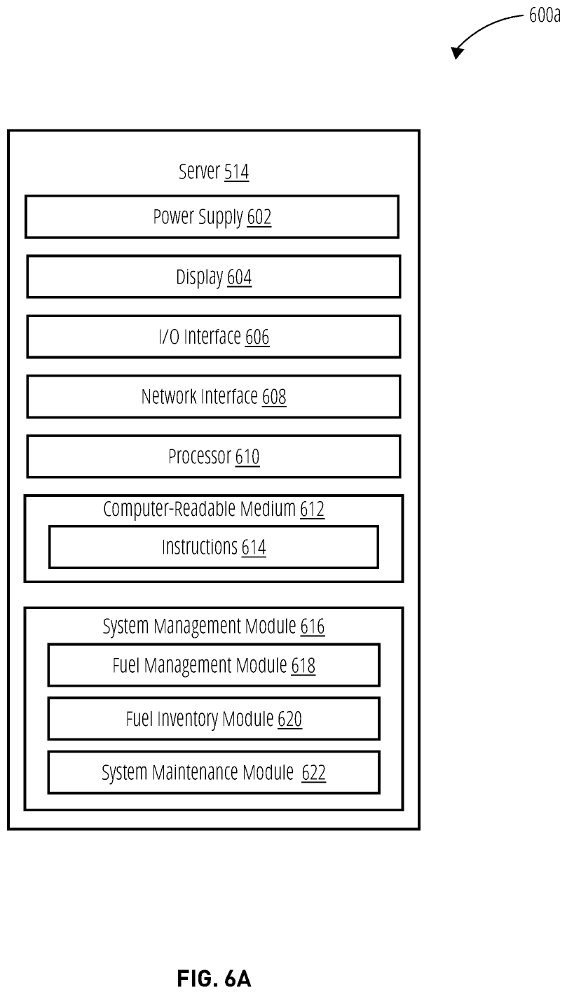

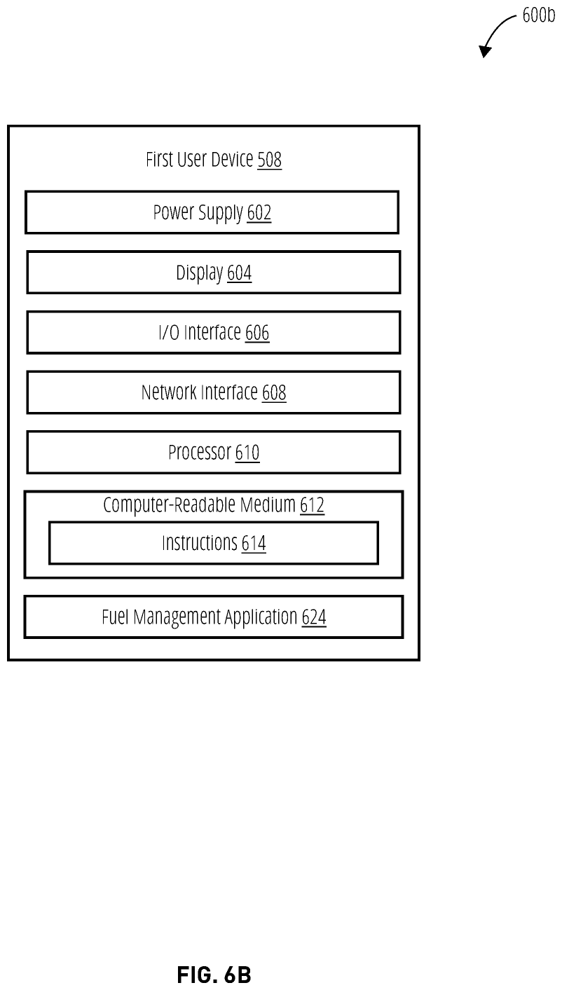

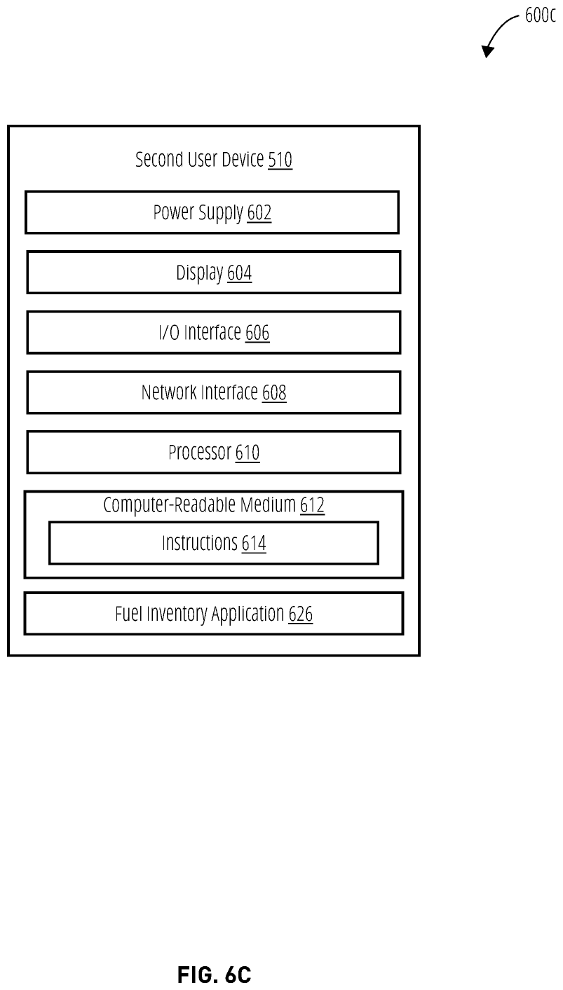

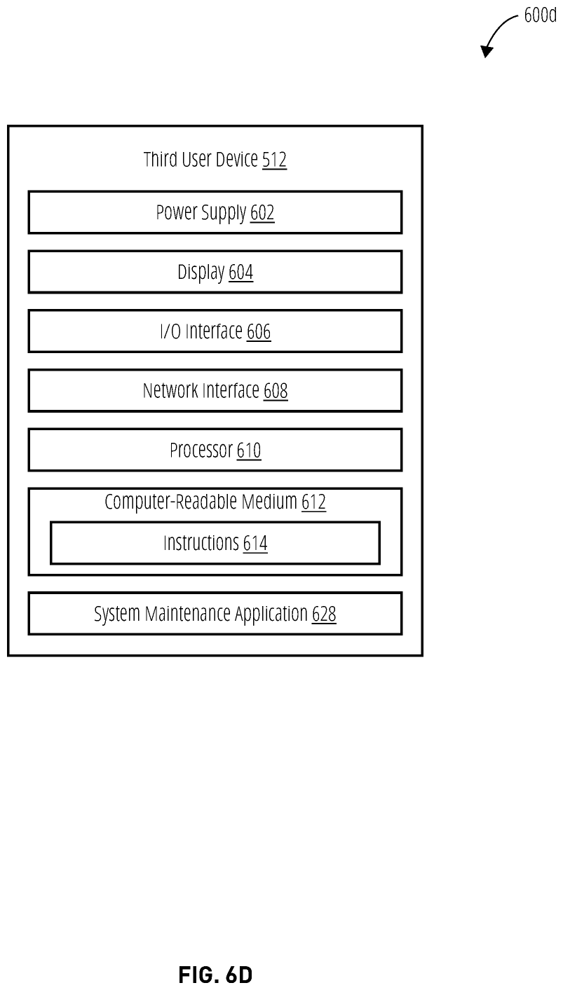

FIG. 6A illustrates an environment 600a of the server 514 of FIG. 5, in accordance with example accordance with examples described herein. FIG. 6B illustrates an environment 600b of the first user device 508 of FIG. 5 (e.g., a smartphone), in accordance with examples described herein. FIG. 6C illustrates an environment 600c of the second user device 510 of FIG. 5, in accordance with examples described herein. FIG. 6D illustrates an environment 600d of the third user device 512 of FIG. 5, in accordance with examples described herein. FIG. 6A, FIG. 6B, FIG. 6C, and FIG. 6D are illustrated and described in the context of FIG. 1, FIG. 2A, FIG. 2B, FIG. 2C, FIG. 2D, FIG. 3, FIG. 4A, FIG. 4B, FIG. 4C, and FIG. 5 and the descriptions thereof.

For the sake of and brevity, the description(s) of some of the components of the server 514, the first user device 508, the second user device 510, and the third user device 512 are described together. For example, one, some, or each of the server 514, the first user device 508, the third user device 512, and may include and/or utilize a respective power supply 602, a respective display 604, a respective input/output (I/O) interface 606, a respective network interface 608, a respective processor 610, a respective computer-readable medium 612 that include(s) instructions 614. Although not explicitly illustrated in the FIG. 6A, FIG. 6B, FIG. 6C, and FIG. 6D, one, some, or all of the server 514, the first user device 508, the second user device 510, and/or the third user device 512 may include other components and sensors, such a camera, a microphone, a gyroscope, an accelerometer, and additional or alternative components and/or sensors.

In some embodiments, in FIG. 6A, FIG. 6B, FIG. 6C, and FIG. 6D, the power supply 602 may provide power to various components within an entity, such as within the server 514, the first user device 508, the second user device 510, and/or the third user device 512. Further, the power supply 602 may include one or more rechargeable, disposable, or hardwire sources, for example, a battery(ies), a power cord(s), an AC to DC inverter (AC-to-DC inverter), a DC-to-DC converter, and/or the like. Additionally, the power supply 602 may include one or more types of connectors or components that provide different types of power (e.g., AC power, DC power) to any device that may be connected to the entity. Additionally, or alternatively, the connector of the power supply 602 may also transmit data to and from a device to another device. For example, in some embodiments, the connector of the power supply 602 may facilitate transmission of data from the server 514 to the database 516.

In some embodiments, regarding FIG. 6A, FIG. 6B, FIG. 6C, and FIG. 6D, the display 604 may be optional in the server 514 and may only be included in the first user device 508, the second user device 510, and the third user device 512. However, if any of the server 514, the first user device 508, the second user device 510, and the third user device 512 includes and/or utilizes a display 604, the display 604 may display visual information, such as an image(s), a video(s), a graphical user interface (GUI), notifications, instructions, transaction data, data related to the system 102, and so forth to a user (e.g., the first user 502, the second user 504, the third user 506). The display 604 may utilize a variety of display technologies, such as a liquid-crystal display (LCD) technology, a light-emitting diode (LED) backlit LCD technology, a thin-film transistor (TFT) LCD technology, an LED display technology, an organic LED (OLED) display technology, an active-matrix OLED (AMOLED) display technology, a super AMOLED display technology, and so forth. Furthermore, the display 604 may be a touchscreen display that may utilize any type of touchscreen technology, such as a resistive touchscreen, a surface capacitive touchscreen, a projected capacitive touchscreen, a surface acoustic wave (SAW) touchscreen, an infrared (IR) touchscreen, and so forth.

In some embodiments, in FIG. 6A, FIG. 6B, FIG. 6C, and FIG. 6D, the I/O interface 606 of any of the server 514, the first user device 508, the second user device 510, and/or the third user device 512 may enable these devices to receive an input(s) from the first user 502, the second user 504, and/or the third user 506. Similarly, the I/O interface 606 of any of the server 514, the first user device 508, the second user device 510, and/or the third user device 512 may provide an output(s) from the first user 502, the second user 504, and/or the third user 506. In some embodiments, the I/O interface 606 of any of the server 514, first user device 508, the second user device 510, and/or the third user device 512 may include, be integrated with, and/or may operate in concert and/or in situ with another component of any of the server 514, the database 516, the first user device 508, the second user device 510, the third user device 512, the electronic recorder 354, the IoT device 346, the network 522, the base station(s) 518, and/or the satellite(s) 520.

In some embodiments, in FIG. 6A, FIG. 6B, FIG. 6C, and FIG. 6D, the network interfaces 608 of any the server 514, the first user device 508, the second user device 510 of FIG. 6C, or the third user device 512 of FIG. 6D may facilitate the receiving and/or transmitting of data directly and/or indirectly between the server 514 of FIG. 6A, the first user device 508 of FIG. 6B, the second user device 510 of FIG. 6C, or the third user device 512 of FIG. 6D. For example, the second user device 510 may communicate with the server 514 directly or via the network 522.

In some embodiments, in FIG. 6A, FIG. 6B, FIG. 6C, and FIG. 6D, the processor 610 of any the server 514, the first user device 508, the second user device 510, or the third user device 512 may be substantially any electronic device that may be capable of processing, receiving, and/or transmitting the instructions 614 that may be included in, permanently or temporarily saved on, and/or accessed by the computer-readable medium 612. In aspects, the processor 610 may be implemented using one or more processors (e.g., a central processing unit (CPU), a graphic processing unit (GPU)), and/or other circuitry, where the other circuitry may include as at least one or more of an application specific integrated circuit (ASIC), a field programmable gate array (ASIC), a microprocessor, a microcomputer, and/or the like. Furthermore, the processor 610 may be configured to execute the instructions 614 in parallel, locally, and/or across the network 522 of FIG. 5, for example, by using cloud and/or server computing resources, such as the server 514.

In some embodiments, in FIG. 6A, FIG. 6B, FIG. 6C, and FIG. 6D, the computer-readable medium 612 of any of the server 514, the first user device 508, the second user device 510, or the third user device 512 may be and/or include any suitable data storage media, such as volatile memory and/or non-volatile memory. Examples of volatile memory may include a random-access memory (RAM), such as a static RAM (SRAM), a dynamic RAM (DRAM), or a combination thereof. Examples of non-volatile memory may include a read-only memory (ROM), a flash memory (e.g., NAND flash memory, NOR flash memory), a magnetic storage medium, an optical medium, a ferroelectric RAM (FeRAM), a resistive RAM (RRAM), and so forth. Moreover, the computer-readable medium 612 does not include transitory propagating signals or carrier waves.

In some embodiments, in FIG. 6A, FIG. 6B, FIG. 6C, and FIG. 6D, the instructions 614 of any of the server 514, the first user device 508, the second user device 510, and/or the third user device 512 may be included in, permanently or temporarily saved on, and/or accessed by the respective computer-readable medium 612 of the server 514, the first user device 508 of FIG. 6B, the second user device 510, and/or the third user device 512. The instructions 614 may include code, pseudo-code, algorithms, configurations, software modules, and/or so forth, and the instructions are executable by one or more processors (e.g., the processor 610).

As is illustrated in FIG. 6A, the server 514 may include, utilize, and/or support a system management module 616. Moreover, the system management module 616 may include, utilize, and/or support more specialized modules, such as a fuel management module 618, a fuel inventory module 620, and a system maintenance module 622. To support the fuel management module 618, the fuel inventory module 620, and the system maintenance module 622, the system management module 616 may include and/or utilize respective application programming interfaces (APIs). In some embodiments, the fuel management module 618 may be primarily utilized by the first user 502, the fuel inventory module 620 may be primarily utilized by the second user 504, and the system maintenance module 622 may be primarily utilized by the third user 506. Additionally, or alternatively, any of the of the first user 502, the second user 504, and/or the third user 506 may utilize the system management module 616, the fuel management module 618, the fuel inventory module 620, and/or the system maintenance module 622.

Focusing on FIG. 6B, in some embodiments, the first user 502 (e.g., a driver, a customer) may install and set up a fuel management application software 624 (“fuel management application 624”) on the first user device 508 (e.g., a smartphone). The fuel management application 624 of FIG. 6B may be compatible with and/or utilizes the fuel management module 618 of FIG. 6A. To do so, the fuel management application 624 may utilize an API that may enable the first user device 508 to utilize the fuel management module 618 of the server 514. When setting up the fuel management application 624, the fuel management application 624 may guide the first user 502 using instructions (e.g., using a GUI) that may be displayed on the display 604 of the first user device 508. The instructions may prompt the first user 502 to enter their name, last name, billing address, email address, mobile number, financial transaction(s) information (e.g., a credit card, a debit card, a digital wallet, a digital currency, a bank account), type of fuel (e.g., LP), a vehicle identification number (VIN), a make and a model of their vehicle, a first quick response (QR) code associated with their vehicle, a combination thereof, and/or other information that may be required by the fuel management application 624, the fuel management module 618, and/or the system management module 616.

In an example method of a liquid-fuel-purchasing transaction, the first user 502 (e.g., an LP customer, a liquid fuel customer) may use their smartphone (e.g., the first user device 508) to initiate and complete the transaction at the fuel station 104 of the system 102. After the first user 502 arrives at the fuel station 104, the first user 502 may couple (e.g., connect, insert) the nozzle(s) 338 of the fuel station 104 to the fuel tank of their vehicle. Since, at this stage, the first user 502 and the first user device 508 are within a Bluetooth Classic® or a BLE® communication range (e.g., within 2, 5, 10, and so forth meters) with the electronic recorder 354 of the fuel station 104, the first user device 508 and the electronic recorder 354 can communicate directly with each other using the Bluetooth Classic® and/or the BLE® communication protocol and/or standard.

To initiate the liquid-fuel-purchasing transaction, the first user 502 may open and/or launch the fuel management application 624 that is installed on their smartphone (e.g., the first user device 508). It is to be appreciated that even if the electronic recorder 354 may not be able to communicate with the server 514 via, for example, the network 522, the first user 502's smartphone can communicate with the server 514 using, for example, an aforementioned cellular communication protocol. It is to be further appreciated that even if the electronic recorder 354 may not include the required resources (e.g., a sufficient amount of processing and/or memory resources) to initiate and/or complete the liquid-fuel-purchasing transaction, the resources of the first user 502's smartphone may include adequate resources to initiate and the complete the liquid-fuel-purchasing transaction.

Continuing with FIG. 6B, in some embodiments, after the first user 502 opens and/or launches the fuel management application 624, the first user 502 may enter a verification code that the system management module 616 of the server 514 may have sent to the first user 502's smartphone (e.g., the first user device 508). The fuel management application 624 may then guide and/or instruct the first user 502 to scan the first QR code that is associated with the vehicle of the first user 502. For example, the first QR code may be printed inside the cap of the fuel tank of the vehicle. After the first user 502 scans the first QR code, the fuel management application 624 identifies the vehicle. The fuel management application 624 may then guide and/or instruct the first user 502 to scan a second QR code that is associated with the fuel station 104. The second QR code may be displayed on a display screen of the electronic recorder 354. After the first user 502 scans the second QR code using their smartphone, the fuel management application 624 identifies the fuel station 104. The screen of the electronic recorder 354 and/or the screen of the first user device 508 may include other instructions and/or options for the first user 502 to select, such as the number of gallons (or liters) the first user 502 desires to purchase, whether the first user 502 desires to purchase a full tank of liquid fuel, and/or other instructions and/or options. In addition to the instructions and/or options, the electronic recorder 354 and/or the first user device 508 may display additional information regarding the liquid-fuel-purchasing transaction, such as the price per volumetric unit (e.g., $ per gallon, € per liter) of the liquid fuel, the total price of the liquid-fuel-purchasing transaction, and/or other information. In some embodiments, after the first user 502 completes the liquid-fuel-purchasing transaction, the display 604 of the first user device 508 may display information regarding the liquid-fuel-purchasing transaction, such as the status of the liquid-fuel-purchasing transaction (e.g., completed), the financial charges of the liquid-fuel-purchasing transaction, the purchased amount of the liquid fuel, and/or other information. Furthermore, the fuel management module 618 and/or the system management module 616 may automatically send a receipt of the liquid-fuel-purchasing transaction to the email address and/or the physical address of the first user 502.

Focusing on FIG. 6C, the second user 504 of FIG. 5 may be associated with and/or working for a fuel distributor, and the second user 504 may install a fuel inventory application software 626 (“fuel inventory application 626”) on the second user device 510. The fuel inventory application 626 of FIG. 6C may be compatible with and/or utilizes the fuel inventory module 620 of FIG. 6A. To do so, the fuel inventory application 626 of FIG. 6C may utilize an API that may enable the second user device 510 to utilize the fuel management module 618 of the server 514. When setting up the fuel inventory application 626, the fuel inventory application 626 may guide the second user 504 using instructions (e.g., using a GUI) that may be displayed on the display 604 of the second user device 510. The instructions may prompt the second user 504 to set a sale price per volumetric unit (e.g., $ per gallon, € per liter) of the liquid fuel; an identification of the fuel station 104 (e.g., fuel station No. 2, Ennis, Texas, USA) and identifications of other fuel stations; a physical address of the fuel station 104; GPS coordinates of the fuel station 104; the second QR code associated with the fuel station 104 and/or the system 102; a name, last name, username, password, job title, and the like of the second user 504; a name, last name, and contact information of the owner of the fuel station 104; a legal, a service, and/or a business contract(s) between the fuel distributor and the owner of the fuel station; a type of fuel in the fuel station 104; and/or other information that enables the second user 504 and/or the fuel distributor to fuel and/or refuel the fuel station 104.

In an example method of using the fuel inventory application 626, the second user 504 may open and/or launch the fuel inventory application 626 that is installed on their laptop (e.g., the second user device 510). The fuel inventory application 626 may then prompt the second user 504 to enter their credentials (e.g., username and password). After entering their credentials, the second user 504 may select the name of the fuel station 104. The fuel inventory application 626 of the second user device 510 allows the second user 504 to view the current fuel inventory of the fuel station 104, the amount of fuel sold by the fuel station 104, and/or other financial data associated with the fuel sold, used, or dispensed by the fuel station 104. It is to be appreciated that the current fuel inventory viewed using the fuel inventory application 626 may include a less-than-1% margin of error. Based on the fuel inventory of the fuel station 104, the second user 504 may determine the appropriate time to refuel the fuel station 104.

Focusing on FIG. 6D, in some embodiments, the third user 506 of FIG. 5 may be an operator, an owner, a maintenance worker, an engineer, and/or the like of the system 102, and the third user 506 may install a system maintenance application software 628 (“system maintenance application 628”) on the third user device 512. The system maintenance application 628 of FIG. 6D may be compatible with and/or utilizes the system maintenance module 622 of FIG. 6A. To do so, the system maintenance application 628 of FIG. 6D may utilize an API that may enable the third user device 512 to utilize the system maintenance module 622 of the server 514. When setting up the system maintenance application 628, the system maintenance application 628 may guide the third user 506 using instructions (e.g., using a GUI) that may be displayed on the display 604 of the third user device 512. The instructions may prompt the third user 506 to add an identification of the fuel station 104 (e.g., fuel station No. 2, Ennis, Texas, USA); a physical address of the fuel station 104; GPS coordinates of the fuel station 104; the second QR code associated with the fuel station 104 and/or the system 102; a name, last name, username, password, job title, and the like of the third user 506; and/or other information related to the maintenance and/or safety of the fuel station 104, the power station 106, and/or the system 102.

In an example method of using the system maintenance application 628, the third user device 512 may open and/or launch the system maintenance application 628 that is installed on their laptop (e.g., the third user device 512). The system maintenance application 628 may then prompt the third user 506 to enter their credentials (e.g., username and password). After entering their credentials, the third user 506 may select the name of the fuel station 104 they intend to monitor. The system maintenance application 628 of the third user device 512 allows the third user 506 to view data related to alarms, notifications, the health of the components of the system 102, and/or other maintenance, performance, and/or safety-related data of the system 102. It is to be appreciated that even though the data related to the alarms, notifications, the health of the components of the system 102, and/or the other maintenance, performance, and/or safety-related data of the system 102 may be locally stored and/or viewed at the electronic recorder 354, instead of going onsite (e.g., at or near the system 102), the third user 506 may use the third user device 512 to communicate with the server 514 and/or access data stored in the database 516.

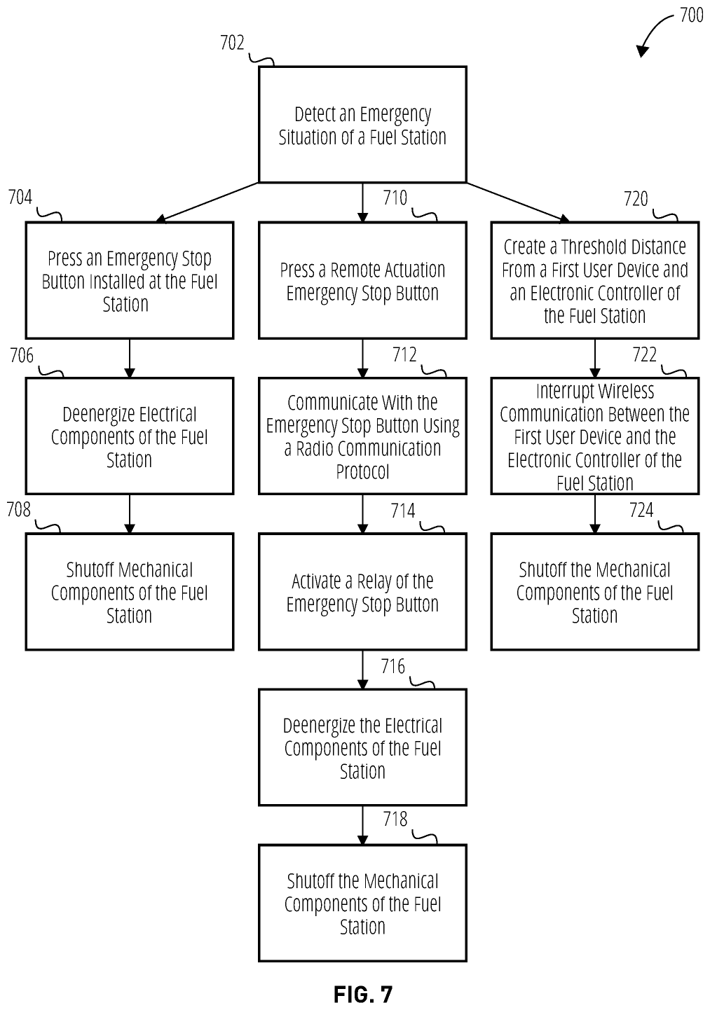

FIG. 7 illustrates an environment 700 of three example methods of preventing or mitigating a leak, an ignition, and/or an explosion of the liquid fuel at the fuel station 104, in accordance with examples described herein. FIG. 7 is described in the context of FIG. 1 to FIG. 6B, and the descriptions thereof. In some embodiments, a combination of the three example methods of preventing a leak, an ignition, and/or an explosion of the liquid fuel at the fuel station 104 may exceed what may be required by the NFPA 58, without adding additional operational steps from a user in a case of an emergency.

At stage 702, a user may detect an emergency situation at the fuel station 104. For example, a user may visually see a leak at the fuel station 104, a notification on the display screen of the electronic recorder 354 of the fuel station 104, a visual and/or an audible alarm (not illustrated), and/or other visual cues of an emergency situation. Additionally, or alternatively, the user may smell a leak (e.g., an LP leak) at the fuel station 104.

In a first example method of preventing or mitigating a leak, an ignition, and/or an explosion of the liquid fuel at the fuel station 104, at stage 704, the user may press the emergency stop 348. Pressing the emergency stop 348 may be particularly advantageous if the user is already located near the emergency stop 348. The stage 704, however, may not be necessarily preceded by an emergency situation at stage 702. For example, the second user 504, who may be associated with a fuel distributor, may press the emergency stop 348 as a precaution, or a routine operation, before refueling the fuel tank 302. As another example, the third user 506, who may be an operator, an owner, a maintenance worker, an engineer, and/or the like of the fuel station 104 and/or system 102, may press the emergency stop 348 before performing a scheduled repair and/or maintenance of the fuel station 104. After a user presses the emergency stop 348, at stage 706, the emergency stop 348 deenergizes some or all of the electrical components of the fuel station 104, including the electric motor 314 and/or the pneumatic solenoid valves (e.g., the first electrically powered solenoid valve 334, the second electrically powered solenoid valve(s) 336). Deenergizing the electrical components of the fuel station may lower the risk of the electricity (e.g., an electric spark) at the fuel station 104 igniting the leaked fuel. Furthermore, at stage 708, deenergizing the electrical components of the fuel station 104 shuts off the electromechanical components of the fuel station 104. Specifically, at stage 708, the pneumatic solenoid valves stop the flow of the fuel supply from the fuel tank 302 of the fuel station 104. Consequently, the first example method (described in steps 704, 706, and 708) prevents or mitigates a leak, an ignition, and/or an explosion of the liquid fuel at the fuel station 104.

Alternatively, in a second example method of preventing or mitigating a leak, an ignition, and/or an explosion of the liquid fuel at the fuel station 104, at stage 710, a user (e.g., the second user 504, the third user 506) may press the remote actuation emergency stop(s) 352. Consequently, at stage 712, the remote actuation emergency stop(s) 352 communicates with the emergency stop 348 using a radio communication protocol. At stage 714, the radio communication protocol activates a relay of the emergency stop 348. The activation of the relay of the emergency stop 348 may perform the same function as manually pressing the emergency stop 348. Specifically, at stage 716, some or all of the electrical components of the fuel station 104, including the electric motor 314 and/or the pneumatic solenoid valves. Deenergizing the electrical components of the fuel station 104 may lower the risk of the electricity (e.g., an electric spark) at the fuel station 104 igniting the leaked fuel. Furthermore, at stage 718, deenergizing the electrical components of the fuel station 104 shuts off the electromechanical components of the fuel station 104. Specifically, at stage 718, the pneumatic solenoid valves stop the flow of the fuel supply from the fuel tank 302 of the fuel station 104. Consequently, the second example method (described in steps 710, 712, 714, 716, and 718) prevents or mitigates a leak, an ignition, and/or an explosion of the liquid fuel at the fuel station 104.

In a third example method of preventing or mitigating a leak, an ignition, and/or an explosion of the liquid fuel at the fuel station 104, the description partly focuses on an instinctive (or intuitive) behavior of a user in the case of an emergency situation. The third example behavior may take into consideration that the first user 502, who may be a customer of the liquid fuel, may not be familiar and/or comfortable with pressing the emergency stop 348. For example, after the first user 502 opens, launches, and/or utilizes the fuel management application 624 of the first user device 508 to purchase liquid fuel, the user may detect an emergency situation at stage 702. The instinct of the first user 502 may be to step, walk, or run away from the liquid fuel that may be leaking from the fuel tank 302, while holding their smartphone (e.g., the first user device 508) in their hand. Consequently, at stage 720, the first user 502 creates a threshold distance from the first user device 508 and the electronic recorder 354, where the threshold distance is greater than a Bluetooth Classic® or a BLE® communication range. Since the first user device 508 and the electronic recorder 354 are outside the Bluetooth Classic® or a BLE® communication range, at stage 722, the first user 502 has caused an interruption of a wireless communication between the first user device 508 and the electronic recorder 354 of the fuel station 104. Consequently, at stage 724, the electronic recorder 354 shuts off the electric motor 314 and/or the pneumatic solenoid valves as a routine operation since the electronic recorder 354 does not allow the fuel station 104 to dispense fuel unless the first user 502 is utilizing the fuel management application 624. The first user 502 may then take additional steps, such as calling an emergency phone number (e.g., 911 in the United States) to report the emergency. It is to be understood that the fuel station 104 does not rely on the stages 720, 722, and 724 as a primary method of preventing or mitigating a leak, an ignition, and/or an explosion of the liquid fuel at the fuel station 104. Nevertheless, it is to be appreciated that the system 102 incorporates additional safety measures, without adding additional operational safety steps.

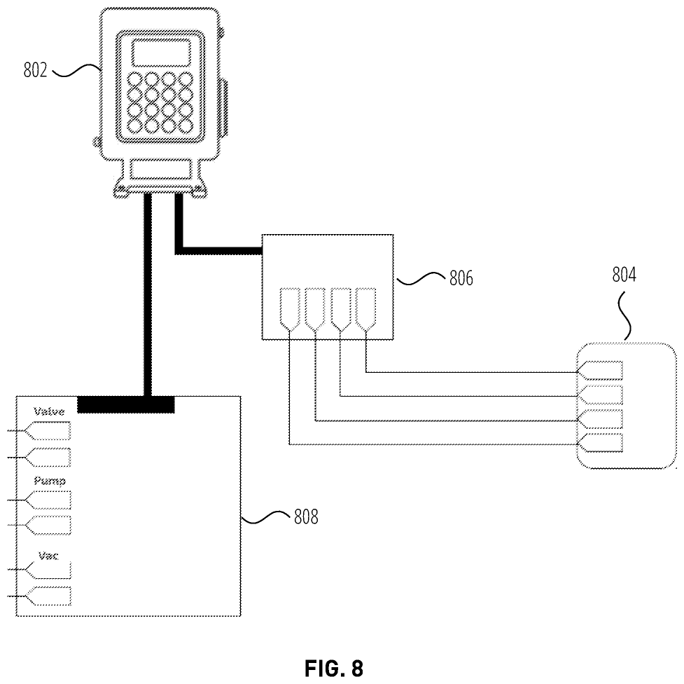

FIG. 8 is a schematic diagram of an electronic recorder 802 according to an embodiment of the present disclosure. In some embodiments, the electronic recorder 802 may be the electronic recorder 354 of FIG. 3. In some embodiments, the electronic recorder 802 may be coupled to a flow controller 808 and a measurement controller 806 that is coupled to a flow meter 804. For the sake of brevity, FIG. 8 illustrates some non-limiting examples of the electronic recorder 802, the flow meter 804, the flow controller 808, and the measurement controller 806 that may be utilized by the fuel station 104.

In some examples, the flow meter 804 may be a mass flow meter. In some examples, the flow meter 804 may include a differential-pressure meter and a co-processor. In some examples, the flow meter 804 may include one or more positive displacement meters and a co-processor. The flow meter 804 may provide an inventory usage through a flow of fuel during a fuel supply operation.

In some embodiments, the electronic recorder 802 may receive data from the flow meter 804 through the measurement controller 806. Responsive to the data, the electronic recorder 802 may provide control signals to the flow controller 808 to activate and deactivate a flow of fuel, adjust a flowing rate of the fuel, and activate and deactivate a power supply (e.g., an alternating current voltage V_{AC}). The flow controller 808 may be coupled to a valve and control to adjust a flowing rate of the fuel responsive to the control signal from the electronic recorder 802. The flow controller 808 may be coupled to a pump and control activation and deactivation of a flow responsive to the control signal from the flow controller 808 to activate and deactivate a flow of fuel by turning on and off the pump. The flow controller 808 may be coupled to the power supply (e.g., an alternating current voltage V_{AC}) and control activation and deactivation of the power supply responsive to the control signal from the flow controller 808 to start or stop providing the flow of the fuel.

In some embodiments, an IoT device 346 of FIG. 3 may be an inventory measurement controller and/or a telemetry device. FIG. 9 is a schematic diagram of an inventory measurement controller 902 according to an embodiment of the present disclosure. The inventory measurement controller 902 may be coupled to one or more sensors attached to either inside or outside a fuel tank, such as the fuel tank 302 of FIG. 3. In some embodiments, the inventory measurement controller 902 may be coupled to the one or more sensors via a sensor interface 904. In some embodiments, the inventory measurement controller 902 and the sensor interface 904 may be implemented as one device. In some embodiments, any combination of the inventory measurement controller 902 and/or a telemetry device 912 may be coupled to the electronic recorder 802 and/or the measurement controller 806 of FIG. 8. In some embodiments, any combination of the sensor interface 904, the inventory measurement controller 902 and/or the telemetry device 912 may be implemented as any combination of the electronic recorder 802 and/or the measurement controller 806 of FIG. 8. For the sake of brevity, FIG. 9 illustrates some non-limiting examples of the inventory measurement controller, telemetry device, sensor interface, and/or sensors that may be utilized by the fuel station 104.

In some examples, the one or more sensors may include a plurality of ultrasonic level sensors 906, a thermometer 908, and a pressure gauge 910. Using the plurality of ultrasonic level sensor 906, a level of fuel inside the fuel tank may be obtained. However, any level meter to obtain a level may be used in place of the plurality of ultrasonic level sensors 906. The thermometer 908 may provide an internal temperature of the fuel tank. The pressure gauge 910 may provide an internal pressure of the fuel tank. Using a combination of the level of fuel, the internal temperature, and the internal pressure, the inventory measurement controller 902 may determine fuel density inside the fuel tank.

In some embodiments, the plurality of ultrasonic level sensors 906 may be attached to a base of the fuel tank, either by utilizing a magnetic housing including the sensors if a wall of the fuel tank is ferromagnetic, or by bonding a housing including the sensors to the wall of the fuel tank if the fuel tank is non-ferromagnetic. The plurality of ultrasonic level sensors 906 may emit a sound wave that travels through a medium of the tank and reflects back from its liquid surface. The time of flight from emission to receiving the signal, together with temperature compensation and density of the liquid, is then processed and calculated by the system to determine the height of the liquid.

In some embodiments, the sensor interface 904 may be coupled to the inventory measurement controller 902, and further coupled to the plurality of ultrasonic level sensors 906, the thermometer 908, and the pressure gauge 910. In some embodiments, the thermometer 908, and the pressure gauge 910 may be coupled in series or in parallel to the sensor interface 904. In some embodiments, the sensor interface 904 may be further coupled to a reference sensor, such as a reference ultrasonic sensor attached to a side of the fuel tank. Data from the one or more sensors received at the sensor interface 904 may be provided to the inventory measurement controller 902.

In some embodiments, the inventory measurement controller 902 may be connected to a telemetry device 912 either wirelessly or in a wired manner. The telemetry device 912 may handle communications among inventory measurement controller 902 and any devices connected to the telemetry device 912 wirelessly or in a wired manner for duplex communications. In some examples, raw data from the one or more sensors or processed data, including density for example, may be sent to a portal (e.g., the server 514) for inventory control analytics accessible via any computer/tablet/mobile. In some examples, the telemetry device 912 may execute automatic firmware/software updates as notified by the portal. In some examples, the telemetry device 912 may provide a communication to a support team for remotely access to diagnose or resolve any issues regarding inventory measurements. In some embodiments, the portal may be the server 514 in FIG. 5. In some examples, the portal may allow a user (e.g., a station controller, etc.) using one or more application software running on a remote device, such as computer/tablet/mobile, to monitor and control tank inventory. Data may be transmitted at a predetermined interval (e.g., every 15 minutes, etc.) to ensure near real-time monitoring various parameters, including, but not limited to, the fuel level and the internal temperature. The portal may store historical data and present the historical data to the user. The portal may set up various alarms for managing minimum or maximum thresholds of these parameters. Furthermore, the portal may also present pressure, density, and mass analysis in a near real-time manner to the user.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention in this regard; no attempt is made to show structural details of the invention in more detail than is necessary for the fundamental understanding of the invention, the description taken with the drawings and/or examples making apparent to those skilled in the art how the several forms of the invention may be embodied in practice.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

What is claimed is:

1. A system, comprising:
a power station;
a fuel station electrically, communicatively, or mechanically coupled to the power station;
a network;
a server comprising:
a system management module comprising:
a fuel management module configured to selectively control an amount of fuel being dispensed at the fuel station;
a fuel inventory module configured to monitor an amount of fuel in the fuel station; and
a system maintenance module configured to monitor an alarm of the system, a notification of the system, a health of a component of the system, a performance metric of the component of the system, or a combination thereof;
a user device configured to communicate with the system management module over the network using a first communication protocol; and
a controller associated with the system, and configured to communicate with the user device using a second communication protocol,
wherein the controller and the user device are configured to selectively control the amount of fuel being dispensed at the fuel station.

2. The system of claim 1 further comprising an emergency stop button,
wherein the emergency stop button is configured to interrupt a flow of power from the power station to one or more electrical components of the fuel station, one or more electromechanical components of the fuel station, or a combination thereof.

3. The system of claim 2 further comprising a remote actuation emergency stop button,
wherein the remote actuation emergency stop button is configured to communicate with a relay of the emergency stop button using a radio communication protocol, and
wherein the relay activation is configured to interrupt the flow of power from the power station to the one or more electrical components of the fuel station, the one or more electromechanical components of the fuel station, or a combination thereof.

4. The system of claim 1, wherein the second communication protocol comprises a threshold range, and
wherein the controller is configured to mechanically close one or more electromechanical components of the fuel station responsive to a separation greater than the threshold range between the user device and the controller.

5. The system of claim 1, wherein the mechanical closure of the one or more electromechanical components interrupts a flow of fuel from a tank of the fuel station.

6. The system of claim 5, wherein the one or more electromechanical components of the fuel station are configured to mechanically close responsive to the flow power interruption.

7. The system of claim 1, wherein the power station further comprises a genset, a battery, one or more solar panels, a direct current (DC) to alternating current (AC) inverter, or a combination thereof.

8. The system of claim 1, wherein the fuel station further comprises a fuel tank, a pump, an electric motor, one or more manually operated mechanical valves, one or more pressure-relief valves, one or more ball valves, one or more bypass valves, one or more electromechanical valves, or a combination thereof.

9. The system of claim 1, wherein the fuel station further comprises an ultrasonic level sensor for measuring the amount of fuel in the fuel station.

10. The system of claim 9, wherein the fuel station further comprises an Internet-of-Things device.

11. The system of claim 10, wherein the Internet-of-Things device is configured to communicate with the ultrasonic level sensor using a third communication protocol and communicate with the system management module over the network using the first communication protocol.

12. The system of claim 1, wherein the fuel station further comprises:
a measurement controller coupled to one or more sensors attached to a tank and configured to provide data from the one or more sensors;
a flow controller coupled to at least one of a pump, a valve, a power supply, or a combination thereof; and
an electronic recorder configured to provide the flow controller with control signals to activate and deactivate a flow of fuel, adjust a flowing rate of the fuel, or activate and deactivate a power supply responsive to the data.

13. The system of claim 1, wherein the fuel station further comprises:
one or more sensors attached to a fuel tank of the fuel station; and
an inventory measurement controller configured to receive at least one of a level of fuel, an internal temperature, and an internal pressure, and further configured to determine fuel density inside the fuel tank, and further configured to provide at least one of the level of fuel, the internal temperature, the internal pressure, or the fuel density inside the fuel tank to the user device.
